(19) United States
(12) Patent Application Publication
(10) Pub. No.: US 2022/0400718 A1
(43) Pub. Date: Dec. 22, 2022

(54) METHOD OF FORMING A COOKED MEAT CHUB FOR PROVIDING INDIVIDUAL PRE-COOKED PUCKS

(71) Applicant: Glenn Valley Foods, L.L.C., Omaha, NE (US)

(72) Inventor: Gary Rohwer, Omaha, NE (US)

(21) Appl. No.: 17/837,261

(22) Filed: Jun. 10, 2022

Related U.S. Application Data
(60) Provisional application No. 63/213,384, filed on Jun. 22, 2021.

(51) Int. Cl. A23L 13/60; A23L 13/00; A23B 4/06

(52) U.S. Cl. CPC A23L 13/67; A23L 13/03; A23B 4/06

(57) ABSTRACT

A meat product and a method of preparing the meat product are disclosed. The meat product includes a chub casing and slices of cooked meat filling the chub casing, wherein the slices are fully cooked before packing into the chub casing. The method includes the steps of freezing a block of meat, tempering the block of meat to reach a final cooled temperature, slicing the block of meat into meat slices, and packing the meat slices into a chub casing, forming a chub. The method further includes chilling the chub, freezing the chub, tempering the chub to reach a second final cooled temperature, and sawing the chub into pucks.

### CROSS-REFERENCE TO RELATED APPLICATION

The present application claims the benefit under 35 U.S.C. § 119(e) of U.S. Provisional Application Ser. No. 63/213,384 filed Jun. 22, 2021 entitled “METHOD OF FORMING A COOKED MEAT CHUB FOR PROVIDING INDIVIDUAL PRE-COOKED PUCKS”, naming Gary Rohwer as inventor, which is incorporated herein by reference in the entirety.

### TECHNICAL FIELD

The present invention generally relates to a meat product, and in particular to a cooked, sliced meat product that is portioned and later heated for consumption.

### BACKGROUND

Thin-sliced meats are commonly used in both hot and cold sandwiches. The production of thin sliced meats, having thicknesses less than ⅛ inch, is difficult to produce manually with a carving knife. Therefore, most thin-sliced meats are sliced via a meat slicer.

Once thin-sliced, the meat may then be cooked. For example, in the production of a cheesesteak sandwich, the meat, such as beef, may be cooked on a grill before placement of the meat on a hoagie or other type of bread and served. Traditionally the progression of cheesesteak preparation from slicing and cooking to serving is a rapid process, as the quality and taste of the cheesesteak may degrade under long processing time or repeated processing cycles (e.g., reheating).

Restaurants and other cooking establishments that serve hot thin-sliced meat sandwiches may purchase frozen chubs, larger portions of wrapped, uncooked sliced meat, that may be cut into smaller single-serving “pucks” and cooked. Frozen pucks of portioned, uncooked, and sliced meat may themselves be sold directly to restaurants.

The increasing popularity of hot sandwiches, particularly in fast-food restaurants, has increased the need for the development of precooked meats that require only heating in a microwave oven, rather than by frying on a grill, decreasing wait times and reducing risk of burns by restaurant workers. However, precooked meats that are frozen into chub or pucks and reheated lose their structural integrity (e.g., become mushy) as well as taste. Furthermore, sliced, precooked meat within frozen chubs has a tendency to “shatter” upon portioning into pucks. Therefore, it would be advantageous to provide a meat product and method that overcomes the shortcomings described above.

### SUMMARY

A method of preparing a meat product is disclosed in accordance with one or more embodiments of the present disclosure. In one embodiment, the method includes freezing a block of meat; tempering the block of meat to reach a first final cooled temperature between 32° F. (0° C.) and 20° F. (−6.7° C.); slicing the block of meat into meat slices; cooking the meat slices; packing the meat slices into a chub casing, forming a chub; chilling the chub; freezing the chub; tempering the chub to reach a second final cooled temperature to approximately 20° F. (−6.7° C.); and sawing the chub into pucks.

A meat product is disclosed in accordance with one or more illustrative embodiments of the disclosure. In one embodiment, the meat product includes a chub casing; and slices of cooked meat filling the chub casing, wherein the slices have a thickness between 0.3 mm and 3 mm, wherein the slices are fully cooked before packing into the chub casing.

A frozen meat product is disclosed, in accordance with one or more embodiments of the disclosure. In one embodiment, the frozen meat product includes a puck portioned from a chub that includes slices of fully cooked meat, wherein the slices of cooked meat have a thickness between 0.3 to 3 mm, wherein the frozen meat product does not include a binder.

### BRIEF DESCRIPTION OF THE DRAWINGS

The numerous advantages of the disclosure may be better understood by those skilled in the art by reference to the accompanying figures in which:

FIG. 1 is a perspective view illustrating a chub and two pucks disposed on a cutting table, in accordance with one or more embodiments of the disclosure;

FIG. 2 is a flow chart illustrating a method for producing pucks containing cooked and thin-sliced meat, in accordance with one or more embodiments of this disclosure;

FIG. 3 is an illustration of a chub in the process being packed by hand, in accordance with one or more embodiments of the disclosure;

FIG. 4 is a plan view illustrating a plastic-lined box containing a layer of frozen pucks, in accordance with one or more embodiments of the disclosure;

FIG. 5A is an illustration of an unheated puck and a heated puck, in accordance with one or more embodiments of the disclosure;

FIG. 5B is an illustration of an unheated puck and a heated puck that has been disturbed by hand, in accordance with one or more embodiments of the disclosure;

FIG. 5C is close-up view illustrating a heated puck that has been disturbed by the hand, in accordance with one or more embodiments of the disclosure; and

FIG. 5D is an illustration of the heated puck and a cheese-lined bun, in accordance with one or more embodiments of the disclosure.

### DETAILED DESCRIPTION OF THE INVENTION

Reference will now be made in detail to the subject matter disclosed, which is illustrated in the accompanying drawings.

Embodiments of the present disclosure are directed to frozen chubs and pucks containing sliced and precooked meat and a method for producing the frozen chub and pucks. The method reduces shattering of the chub upon slicing into pucks. The method also reduces the losses of structural integrity and taste in the pucks once they are reheated.

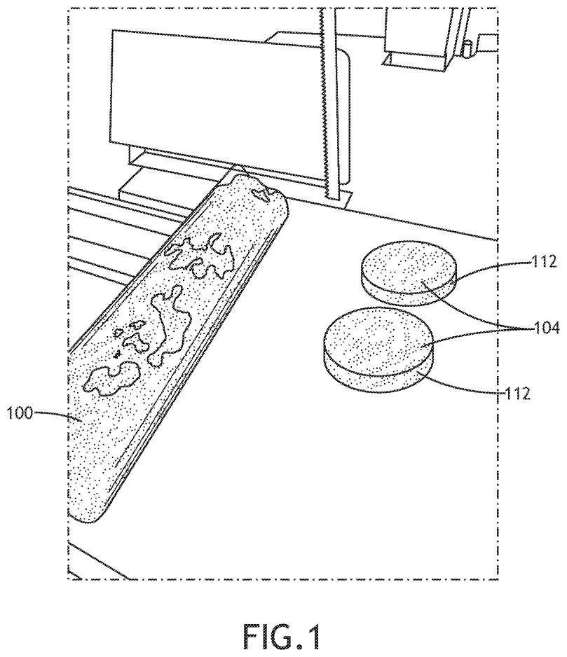

FIG. 1 illustrates a chub 100 and two pucks 104 disposed on a cutting table 108, in accordance with one or more embodiments of the disclosure. In embodiments, the pucks 104 are sliced from the chub 100 when the chub 100 is frozen. Once removed from the chub 100, each puck 104 may contain one or more servings of meat than can be heated and served. In embodiments, the chub 100 and pucks are encircled by a chub casing 112 used initially to package the chub 100 and reduce contamination. The chub casing 112 may be removed before serving.

The chub 100 may contain sliced and cooked meat from one or more of any species of animal, including but not limited to cattle, chicken, pigs, turkey, sheep, goats, buffalo, horse, camel, and fish. For example, the chub may contain beef from a grass- or corn-fed steer. The chub may also include cultured meat. The chub may contain sliced and cooked meat from one or more of any cut of meat including but not limited to a chuck but, a brisket cut, a shank cut, a rib cut, a plate cut, a short loin cut, a sirloin cut, a tenderloin cut, a bottom sirloin cut, a round cut, or a flank cut. For example, the chub may contain a sirloin cut of beef from a corn-fed steer. In another example, the chub may include beefsteak, defined as a slice of meat taken from the loin or the hindquarters a cow, bull, or steer.

In embodiments, chub 100 contains meat slices that have been fully cooked before packaging into the chub. For example, the meat slices may be safely consumed upon thawing of the chub 100 and pucks 104 without the need for further cooking. The meat product within the chub 100 may be fully cooked after slicing or before slicing, and may be cooked in any manner before placement into the chub. For example, the meat may be sliced and cooked on a grill before packaging into the chub. In another example, the meat may be sliced and cooked in a steam jacketed cooker before packaging into the chub.

In embodiments, the chub 100 contains cooked and sliced meat of any slicing thickness or range of slicing thickness. For example, the meat slices may be approximately 1.37 mm (e.g., 0.054 inch) thick. In another example, the meat slices may be approximately 3 mm thick. In another example, the meat slices may be approximately 0.3 mm thick. In another example, the meat slices may range in thickness from 0.012 inches (0.3 mm) to 0.12 inches (3 mm).

In embodiments, the pucks may be portioned to any weight including but not limited to approximately 2.0 ounces, approximately 2.5 ounces, approximately 3.0 ounces, approximately 3.5 ounces, approximately 4.0 ounces, approximately 4.5 ounces, and approximately 5.0 ounces. The pucks may also be portioned into any range of weights including but not limited to 1.0 to 10.0 ounces, 2.0 to 5.0 ounces, and 2.5 to 4.5 ounces.

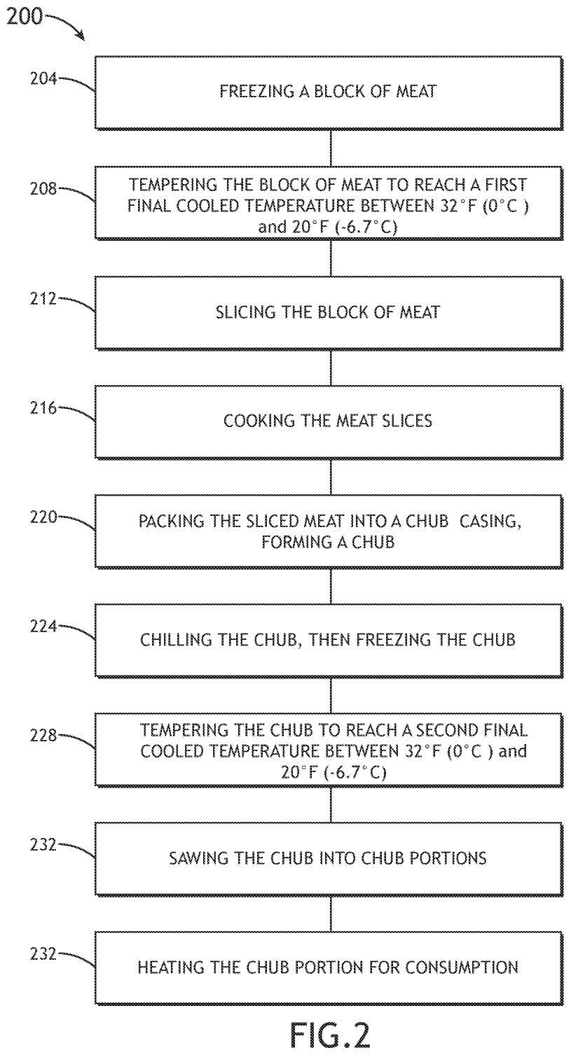

FIG. 2 is a flow chart illustrating a method 200 for producing a meat product (e.g., pucks 104) containing cooked and thin-sliced meat, in accordance with one or more embodiments of this disclosure. The pucks 104 may be heated and served at any restaurant, convenience store, home, or other place for consumption.

In embodiments, the method 200 includes a step 204 of freezing a block of meat. The block of meat may contain any type or cut of meat as stated herein. The block of meat, or a core of the block of meat, may be frozen to any temperature including but not limited to approximately 0° F. (−17.8° C.), approximately 5° F. (−15° C.), approximately 10° F. (−12.2° C.), approximately 15° F. (−9.4° C.), approximately 20° F. (−6.7° C.) approximately −4° F. (−20° C.), approximately −109.3° F. (−78.5° C.), approximately −122° F. (−80° C.), and approximately −320° F. (−196° C.). The block of meat, or a core of the block of meat, may be frozen to any range of temperatures including but not limited to 20° F. (−6.7° C.) to −320° F. (−196° C.), 20° F. (−6.7° C.) to −122° F. (−80° C.), 20° F. (−6.7° C.) to −4° F. (−20° C.), and 5° F. (−15° C.) to −4° F. (−20° C.). In embodiments, the block of meat is frozen to a temperature equal to, or lower than, 0° F. (−17.8° C.).

In embodiments, the method 200 includes a step 208 of tempering the block of meat to reach a first final cooled temperature between 0° C. and −10° C. (32° F. and 14° F., respectively) or between 0° C. and −6.7° C. (32° F. and 20° F., respectively). The first final cooled temperature may be configured as any temperature between 0° C. and −10° C. (32° F. and 14° F.) including but not limited to approximately 32° F. (0° C.), approximately 28° F. (−2.2° C.), approximately 24° F. (−4.4° C.), approximately 20° F. (−6.7° C.), approximately 16° F. (−8.9° C.), and approximately 14° F. (−10° C.). The first final cooled temperature may be configured as any range of temperature including but not limited to 32° F. (0° C.) to 14° F. (−10° C.), 28° F. (−2.2° C.) to 16° F. (−8.9° C.), 24° F. (4.4° C.) to 18° F. (−7.8° C.), and 21° F. (−6.1° C.) to 19° F. (−7.2° C.).

Tempering the block of meat is important as many downstream processes (e.g., slicing, cooking) are dependent on specific tempering protocols. Tempering may include applying a single warming cycle or any number of cooling and warming cycles to the block of meat. For example, tempering may include applying three cooling/warming cycles between 14° F. (−10° C.) and 24° F. (−4.4° C.) (e.g., the highest warming temperature of a cooling/warming cycle is equal to, or less than 24° F. (−4.4° C.), and the lowest cooling temperature of the cooling/warming cycles is equal to, or greater than, 14° F. (−10° C.)). Tempering may also include a set amount of time that a block of meat is kept at a specific temperature (e.g., pre-final cooled temperature). For example, tempering may include keeping a block of meat at 14° F. (−10° C.) for four hours before warming the block of meat to the first final cooled temperature. For instance, tempering may include keeping a block of meat at 14° F. (−10° C.) for approximately four hours before warming the block of meat to the first final cooled temperature. In another instance, tempering may include keeping a block of meat at 14° F. (−10° C.) for more than four hours before warming the block of meat to the first final cooled temperature.

Tempering the block of meat may also include specific rates of cooling or warming. For example, tempering may include warming the block of meat at a rate of 1° F. per hour. In another example, tempering may include cooling the block of meat at a rate of 1° C. per hour. Any rate of warming or cooling may be used.

In embodiments, the method 200 includes a step 212 of slicing the block of meat. The block of meat may be sliced via any technology including but not limited to a meat slicer. The block of meat may be sliced into any slice thickness as described herein. For example, the block of meat may be sliced into sliced approximately 0.054 inches (0.137 cm) thick (e.g., approximately 0.05 inches or 0.14 centimeters thick). The slices may be configured as any shape including but not limited to strips and circles.

In embodiments, the method 200 includes a step 212 of slicing the block of meat. The block of meat may be sliced via any technology including but not limited to a meat slicer. The block of meat may be sliced into any slice thickness as described herein. For example, the block of meat may be sliced into sliced approximately 0.054 inches (0.137 cm) thick (e.g., approximately 0.05 inches or 0.14 centimeters thick). The slices may be configured as any shape including but not limited to strips and circles.

In embodiments, the method 200 includes a step 220 of packing the sliced meat into the chub casing 112 forming the chub 100. Care must be taken in packing the sliced meat into the chub casing 112 to prevent a loss of structural integrity of the meat slices, resulting in an unstructured mash. The sliced meat may be packed into the chub casing via any method and/or device that prevents loss of structural integrity of the meat slices including not limited to stuffing the chub by hand or by the use of a pneumatic plunger. For example, the pneumatic plunger, operating under pressures that pack the meat slices firmly within the chub casing 112, but not to the point of destroying the texture of the meat slices.

The pneumatic plunger may operate under any pressure, or apply a force. including but not limited to approximately 25 psi (pounds per square inch), approximately 50 psi, approximately 75 psi, approximately 100 psi, approximately 125 psi, approximately 150 psi, approximately 175 psi, and approximately 200 psi. The pneumatic plunger may operate under any ranges of pressures including but not limited to 10 psi to 1000 psi, 25 psi to 500 psi, 50 psi to 250 psi, 75 psi to 150 psi, and 80 psi to 120 psi.

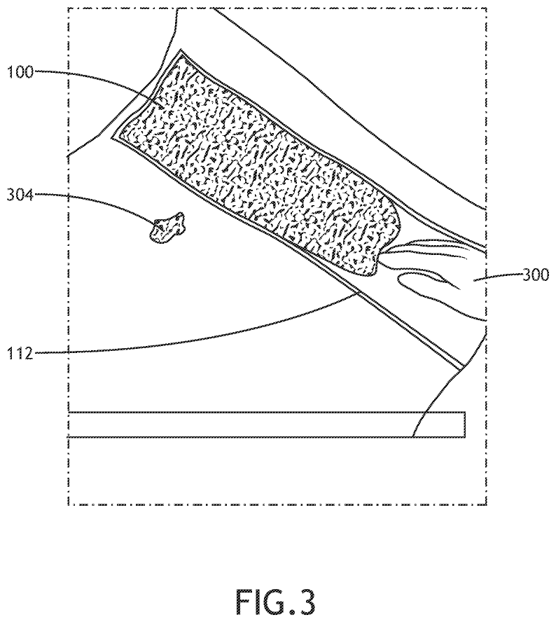

FIG. 3 is an illustration of a chub 100 in the process being packed by hand 300, in accordance with one or more embodiments of the disclosure. Meat slices 304 are introduced into one end of the chub casing 112, and packed until the chub casing 112 is filled to the requisite amount. As with packing via the pneumatic plunger, packing by hand ensures that overt force is not used that would otherwise destroy the texture of the meat slices.

Referring again to FIG. 2, in embodiments, the method 200 further includes a step 224 of chilling the chub 100, then freezing the chub 100. For example, the chub may first be chilled as required by the Food Safety and Inspection Service (FSIS) an agency of the United States Department of Agriculture (USDA). After a chilling protocol, the temperature of the chub 100 may then be lowered to a freezing temperature including but not limited to 0° F. (−17.8° C.), approximately 5° F. (−15° C.), approximately 10° F. (−12.2° C.), approximately 15° F. (−9.4° C.), approximately 20° F. (−6.7° C.) approximately −4° F. (−20° C.), approximately −109.3° F. (−78.5° C.), approximately −122° F. (−80° C.), and approximately −320° F. (−196° C.). The chub 100 may be lowered to a range or freezing temperatures including but not limited to 20° F. (−6.7° C.) to −320° F. (−196° C.), 20° F. (−6.7° C.) to −122° F. (−80° C.), 20° F. (−6.7° C.) to −4° F. (−20° C.), and 5° F. (−15° C.) to −4° F. (−20° C.). Once frozen, moisture upon the surface of the meat slices 304 also freezes the individual meat slices together, and converting the chub 100 into a stiff frozen mass. It is important to note that the chub 100 does not include or need a binder to bind the meat slices 304 together. The tempering steps of the method 200 reduce or negate the need of a binder. Binders are additive edible materials that are added to the meat product to prevent crumbling of the meat, or loss of meat structure. Binders include but are not limited to soy protein concentrate, protein isolates, cellulose, fiber isolates, non-fat dry milk, carrageenan gum, starch and maltodextrin.

In embodiments, the method 200 further includes a step 228 of tempering the chub to reach a second final cooled temperature between 0° C. and −10° C. (32° F. and 14° F., respectively) or between 0° C. and −6.7° C. (32° F. and 20° F., respectively). The tempering of the chub 100 increases the survivability/structural integrity of the chub 100 and individual meat slices 304 during the slicing/sawing process (e.g., into pucks), preventing a shattering of the meat slices 304. Similar to the first final cooled temperature, the second final cooled temperature may be configured as any temperature between 0° C. and −10° C. (32° F. and 14° F.) including but not limited to approximately 32° F. (0′C), approximately 28° F. (−2.2° C.), approximately 24° F. (−4.4° C.), approximately 20° F. (−6.7° C.), approximately 16° F. (−8.9° C.), and approximately 14° F. (−10° C.). The second final cooled temperature may be configured as any range of temperatures including but not limited to 32° F. (0° C.) to 14° F. (−10° C.), 28° F. (−2.2° C.) to 16° F. (−8.9° C.), 24° F. (−4.4° C.) to 18° F. (−7.8° C.), and 21° F. (−6.1° C.) to 19° F. (−7.2° C.).

The tempering of step 228 may include a single warming cycle or any number of cooling and warming cycles. For example, tempering may include three cooling/warming cycles between 14° F. (−10° C.) and 24° F. (4.4° C.). The tempering may also include a set amount of time that the chub 100 is kept at a specific temperature. For example, tempering may include keeping the chub at 14° F. (−10° C.) for four hours before warming the chub to the first final cooled temperature.

The chub 100 may be tempered for any ranges of time including but not limited to five to 15 hours, two to six hours, three to five hours, or approximately four hours. For example, a chub 100 may be initially frozen at 0° F. (−17.8° C.), then tempered (e.g., stored in a freezer) at 20° F. (−6.7° C.) for four hours.

Tempering the chub 100 may also include specific rates of cooling or warming. For example, tempering may include warming the chub at a rate of 1° F. per hour. In another example, tempering may include cooling the chub at a rate of 1° C. per hour. Any rate of warming or cooling may be used.

In embodiments, the method 200 further includes a step 232 of sawing the chub 100 into pucks 104. For example, the chub 100 may be transversely sawed into pucks 104 of any thickness including but not limited to a ¼-inch thickness, a ½-inch thickness, a ¾-inch thickness, a one-inch thickness, a two-inch thickness, and a three-inch thickness. The pucks may be transversely sawed into any range of thicknesses including but not limited to between ¼-inch thickness and three-inch thickness, between ½-inch thickness and two-inch thickness, and between ¾-inch thickness and a one-inch thickness. The puck 104 may comprise any number of servings, including but not limited to one serving, two servings, three servings, four servings, five serving, or six servings.

The sawing of the chub 100 may be performed manually (e.g., via a knife or handsaw) or automatically. For example, the chub 100 may be sliced via a band saw. For instance, the chub 100 may be sliced by a culinary band saw, configured to prevent the puck from shattering. In another example, the chub 100 may be sliced using a conventional rotary slicer. Once the chub 100 has been sawed into pucks 104, the pucks are then packed further for commerce.

In embodiments, the method 200 further includes a step 236 of heating the puck 104 for consumption. The puck 104 may be heated via any technology including but not limited to a microwave oven, conventional oven, grill (e.g., flat top grill) convection oven, hotplate, or open fire. As the meat product within the puck 104 is already cooked, the meat only needs to be warmed as needed.

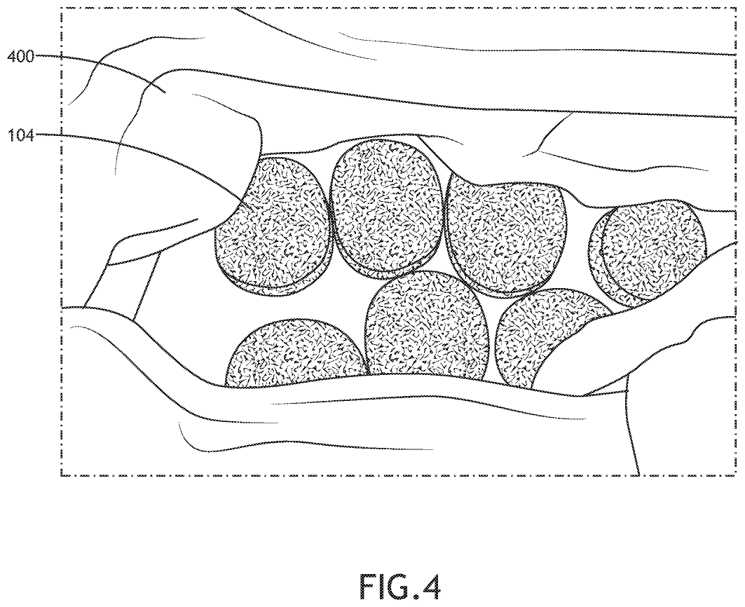

FIG. 4 is an illustration of a plastic-lined box 400 containing a layer of frozen pucks 104, in accordance with one or more embodiments of the disclosure. For production of a meat product (e.g., a cheesesteak sandwich), a food worker need only to heat the puck (e.g., in a microwave oven) and serve the product directly or further use the food product, as in the production of a sandwich.

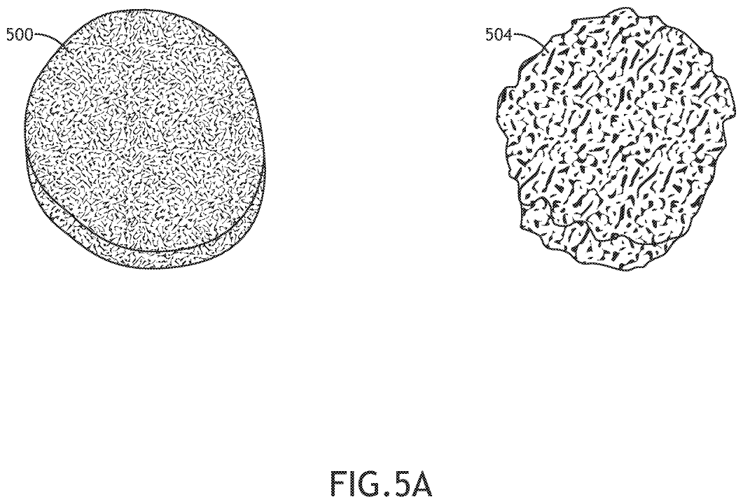

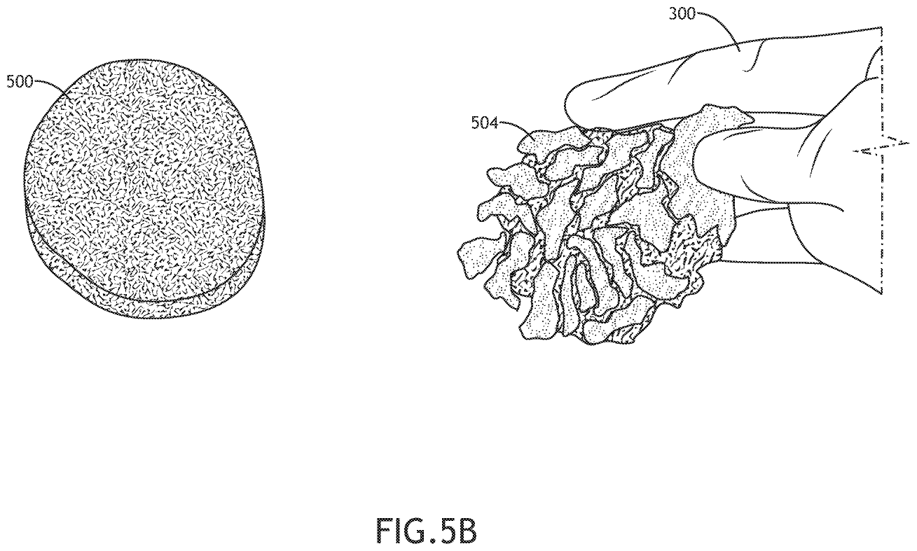

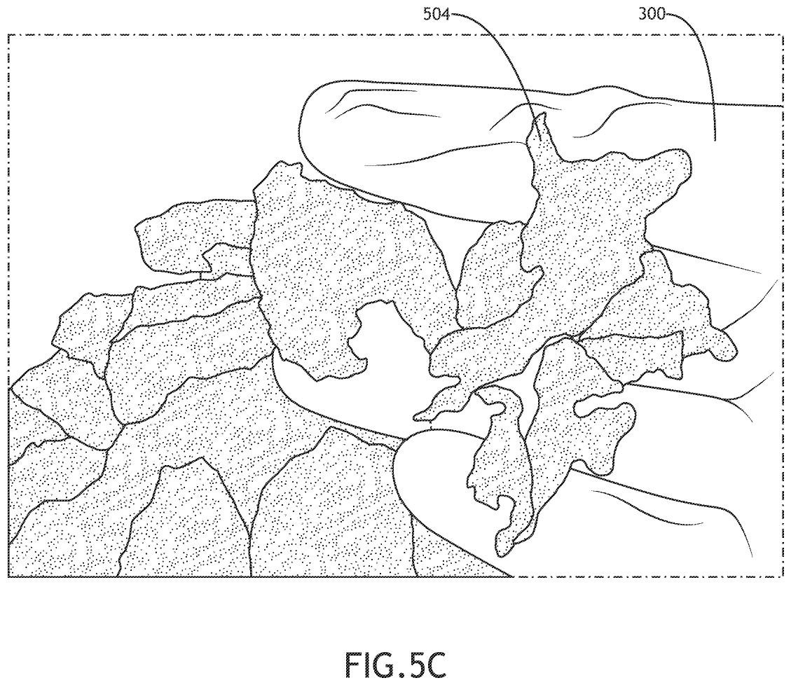

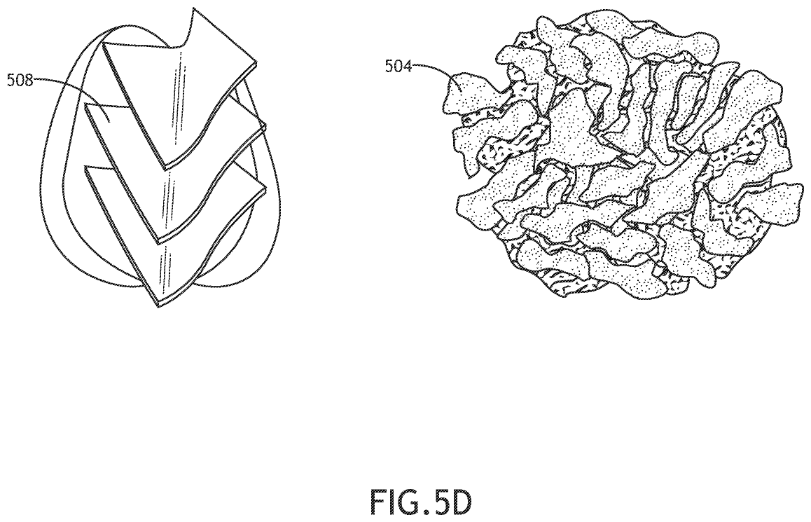

FIG. 5A is an illustration of an unheated puck 500 and a heated puck 504, in accordance with one or more embodiments of the disclosure. The unheated puck 500 remains frozen solid, whereas the heated puck 504 had been heated as intended for consumption. Individual meat slices 304 can be seen on the surface of the heated puck 504, indicating that the meat slices 304 have maintained structural integrity.

FIG. 5B is an illustration of the unheated puck 500 and the heated puck 504 that has been disturbed by hand 300, in accordance with one or more embodiments of the disclosure. The disruption of the puck further indicates that the entirety of the puck 104 has retained structural integrity of the meat slices 304 heated and not turned into an unstructured mash.

FIG. 5C is close-up view of the heated puck 504 that has been disturbed by the hand 300, in accordance with one or more embodiments of the disclosure. The close-up view shows in great detail the retained structure of the meat slices 304 after heating, with no portion of the meat slices 304 formed into an unstructured mash.

FIG. 5D is an illustration of the heated puck 504 and a cheese-lined bun 508, in accordance with one or more embodiments of the disclosure. After heating, the heated puck 504 may be added to the cheese-lined bun 508 to create a cheesesteak sandwich. Because the heated puck 504 is pre-sliced and pre-cooked, no further steps are needed for cooking the heated puck 504 beyond simple heating (e.g., in a microwave oven). The carefully controlled steps in the heating/cooling, slicing, and packaging of the puck 104 ensure that the meat slices within the puck 104 do not lose structural integrity through the production and heating process, and that the heated puck 504 is palatable.

One skilled in the art will recognize that the herein described components, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Although particular embodiments of this invention have been illustrated, it is apparent that various modifications and embodiments of the invention may be made by those skilled in the art without departing from the scope and spirit of the foregoing disclosure. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Accordingly, the scope of the invention should be limited only by the claims appended hereto.

What is claimed:

1. A method of preparing a meat product comprising:
freezing a block of meat;
tempering the block of meat to reach a first final cooled temperature between 32° F. (0° C.) and 20° F. (−6.7° C.);
slicing the block of meat into meat slices;
cooking the meat slices;
packing the meat slices into a chub casing, forming a chub;
chilling the chub;
freezing the chub;
tempering the chub to reach a second final cooled temperature to approximately 20° F. (−6.7° C.); and
sawing the chub into pucks.

2. The method of claim 1, wherein the chub does not include a binder.

3. The method of claim 1, wherein the chub casing is packed via a pneumatic plunger.

4. The method of claim 1, wherein slicing the chub is performed via a band saw.

5. The method of claim 1, wherein freezing the block of meat includes freezing the block of meat to a temperature equal to, or lower than, 0° F. (−17.8° C.).

6. The method of claim 1, wherein tempering the block of meat includes applying two or more cooling/warming cycles to the block of meat.

7. The method of claim 6, wherein a highest warming temperature of the two or more cooling/warming cycles is equal to, or less than 24° F. (−4.4° C.).

8. The method of claim 6, wherein a lowest cooling temperature of the two or more cooling/warming cycles is equal to, or greater than, 14° F. (−10° C.).

9. The method of claim 6, wherein tempering the block of meat includes keeping the block of meat at a pre-final cooled temperature for four or more hours.

10. The method of claim 9, wherein the pre-final cooled temperature is 14° F. (−10° C.).

11. The method of claim 10, wherein tempering the block of meat includes warming the block of meat at a rate of 1° F. (0.56° C.) per hour.

12. The method of claim 1, wherein slicing the block of meat into the meat slices includes slicing the meat slices to a thickness ranging from 0.012 inches (0.3 mm) to 0.12 inches (3 mm).

13. The method of claim 1, wherein slicing the block of meat into the meat slices includes slicing the meat slices to a thickness of approximately 0.05 inches (0.14 cm).

14. The method of claim 1, wherein the meat product contains beefsteak.

15. The method of claim 1, wherein packing the meat slices includes applying a force of 100 psi to the meat slices to form the chub.

16. A meat product comprising:
a chub casing; and
slices of cooked meat filling the chub casing, wherein the slices have a thickness between 0.3 mm and 3 mm, wherein the slices are fully cooked before packing into the chub casing.

17. The meat product of claim 16, wherein the meat product does not contain a binder.

18. The meat product of claim 16, wherein the meat product includes beefsteak.

19. A frozen meat product comprising:
a puck portioned from a chub comprising slices of fully cooked meat, wherein the slices of cooked meat have a thickness between 0.3 and 3.0 mm, wherein the frozen meat product does not include a binder.

20. The frozen meat product of claim 19, wherein the frozen meat product includes beefsteak.
